(19) United States
(12) Patent Application Publication
(10) Pub. No.: US 2007/0112636 A1
(43) Pub. Date: May 17, 2007

(54) Community Based Marketing System and Method

(76) Inventor: William G. Lucker JR., Braselton, GA (US)

Correspondence Address: PHILIP H. BURRUS, IV, 460 Grant Street, Atlanta, GA, 30312, US

(21) Appl. No.: 11/467,020

(22) Filed: Aug. 24, 2006

Related U.S. Application Data
(60) Provisional application No. 60/597,147, filed on Nov. 14, 2005.

(51) Int. Cl. G06Q 30/00

(52) U.S. Cl. 705/26

(57) ABSTRACT

A system and method for facilitating incentive delivery from vendors to communities is provided through a networked system. Members of a community, which is a group of consumers having a common association characteristic, access the networked system by entering a unique community identifier in a member interface portal. Upon accessing the system, the members may view incentives, such as coupons, promotional materials, and advertisements, which have been targeted to their community by a vendor. Vendors may access a networked vendor portal to select target communities, create incentives, and manage incentives. With the system, a vendor may create a unique incentive targeted to one or more communities.

### CROSS REFERENCE TO PRIOR APPLICATIONS

This application claims priority and benefit under 35 U.S.C. §119(e) from U.S. Provisional Application No. 60/597,147, filed Nov. 14, 2005, which is incorporated by reference for all purposes.

### BACKGROUND

1. Technical Field

This invention relates generally to a method and system for a vendor to deliver promotional material to a prospective customer, and more particularly to a networked community based promotional material delivery method and system where a vendor may select a target group of consumers for delivery of customized promotional materials.

2. Background Art

Computer networks, such as the Internet and World Wide Web, have experienced explosive growth in the recent past. Nowhere is this more evident than in the world of on-line commerce. While once a customer had to physically visit a vendor to make a purchase, today millions of people shop and make purchases via the Internet. On-line commerce has enabled people in the most remote communities to have access to goods and services in the largest cities. Even where customers still visit vendors, in the case of restaurants for example, those customers often “surf the web” for information about the vendor, including directions, reviews, and hours.

One problem associated with this rapid growth in electronic commerce relates to the ability of a business to reach customers for advertising. In traditional advertising channels, such as radio and television, the limited number of channels permitted a business only to deliver general advertising, with the hope that new prospective customers would be among the general audience. In the on-line world, however, there are millions and millions of websites. It is extremely difficult for a business to deliver promotional materials, such as coupons and discounts, to new prospective customers.

One prior art solution to this problem is that of banner advertising. Businesses are able to contract with on-line search engines to have a banner ad placed alongside a search result, when the search is related in someway to the business. For example, a sporting goods store may have a banner ad appear when a person searches for “baseball gloves.”

The problem with this prior art solution is that the business is not able to directly select who will see the banner ad. Further, since the business has no way of knowing exactly who will view the banner ad, the business is unable to customize coupons and discounts to appropriate target audiences.

There is thus a need for an improved method and system for a vendor to deliver targeted promotional materials to consumers.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a system for delivering an incentive to a predetermined group of customers in accordance with the invention.

FIG. 2 illustrates one embodiment of a method for delivering an incentive from a vendor to a plurality of customers in accordance with the invention.

FIG. 3 illustrates one embodiment of a method for notifying a vendor of a group specific event in accordance with the invention.

FIG. 4 illustrates one embodiment of a method of receiving a vendor request from a consumer in accordance with the invention.

FIG. 5 illustrates one embodiment of presenting consumer information to a vendor in accordance with the invention.

FIG. 6 illustrates one embodiment of a welcome page to an on-line interface portal in accordance with the invention.

FIG. 7 illustrates one embodiment of a member interface portal in accordance with the invention.

FIG. 8 illustrates one embodiment of member browser readable content organized categorically in accordance with the invention.

FIG. 9 illustrates one embodiment of member browser readable content organized geographically in accordance with the invention.

FIG. 10 illustrates one embodiment of member browser readable content organized in tabular fashion in accordance with the invention.

FIG. 11 illustrates one embodiment of member browser readable content for notifying vendors of an event in accordance with the invention.

FIG. 12 illustrates one embodiment of member browser readable content for requesting a vendor in accordance with the invention.

FIG. 13 illustrates one embodiment of a vendor interface portal in accordance with the invention.

FIG. 14 illustrates one embodiment of vendor browser readable content organized geographically in accordance with the invention.

FIG. 15 illustrates one embodiment of vendor browser readable content organized in tabular fashion in accordance with the invention.

FIG. 16 illustrates one embodiment of an incentive creation portal in accordance with the invention.

FIG. 17 illustrates one embodiment of an incentive creation portal in accordance with the invention.

FIG. 18 illustrates one embodiment of an incentive management portal in accordance with the invention.

FIG. 19 illustrates one embodiment of a vendor incentive management view in accordance with embodiments of the invention.

FIG. 20 illustrates one embodiment of an incentive creation tool in accordance with the invention.

Skilled artisans will appreciate that elements in the figures are illustrated for simplicity 5 and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to providing incentives, such as coupons and discounts, from a vendor to a target group of consumers. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits and components, some, most, or all of the functions of providing targeted incentives from customers to vendors as described herein. The conventional processors may include those in computers, such as personal computers and servers. Further, the non-processor circuits and components may include, but are not limited to, routers, switches, networks such as the Internet and World Wide Web, databases, signal drivers, clock circuits, power source circuits, and user input devices. As such, functions may be interpreted as steps of a method to perform targeted incentive delivery from a vendor to a group of consumers. Alternatively, some or all functions could be implemented with software code or embedded instruction code. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of“a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one currently under discussion. For example, talking about a device (10) while discussing figure A would refer to an element, 10, shown in figure other than figure A.

Embodiments of the present invention provide a method and system for delivering an incentive, such as an advertisement, discount, or coupon, from a vendor to a plurality of consumers. In one embodiment, the vendor may select from a group of “communities”, each having a group of consumers linked by a common association characteristic associated therewith, to whom the incentive will be delivered. A community may be described as a group of people that are linked by an organizational structure. Examples include businesses, schools, churches, synagogues, sporting and recreational teams and leagues, and neighborhood organizations. As the vendor is able to select one or more community to which the incentive will be delivered, the vendor is able to customize or tailor the incentive to that particular group when desired.

An interface portal, for example a website viewable through a web browser, provides a community interface and a vendor interface. When a community member wishes to view incentives directed to his community, he logs into the member interface portal by entering a unique community identifier. Once logged in, the member is able to view incentives directed to his community. These incentives may be viewed in a variety of ways, including in tabular form, by category, chronologically on a calendar, or geographically by location. Further, the member may request certain vendors to participate in the system.

Vendors enter the portal in a similar manner, by entering a unique vendor identifier. Once logged in, the vendor may create incentives targeted to specific communities. In one embodiment, the incentive is a coupon. By way of example, suppose the vendor is a restaurant. Where the target community selected is a retirement community, the restaurant may offer a group discount for early diners. Where the target community selected is a business, the restaurant may offer lunch specials to the employees. By selecting a target community, the vendor knows that the incentive will be delivered to that community and no other. Accordingly, the vendor may create special promotional materials tailored to that community's needs.

In one embodiment, a consumer is able to enter community events. For example, where the community is a church, one member may enter a Saturday church barbecue as a special event. This event, in turn, is then delivered to the applicable, or all, vendors. Restaurants may see the event, and given the large number of consumers, may offer an expiratory discount on catering for that specific event. Similarly, a photographer may offer a discount for the event.

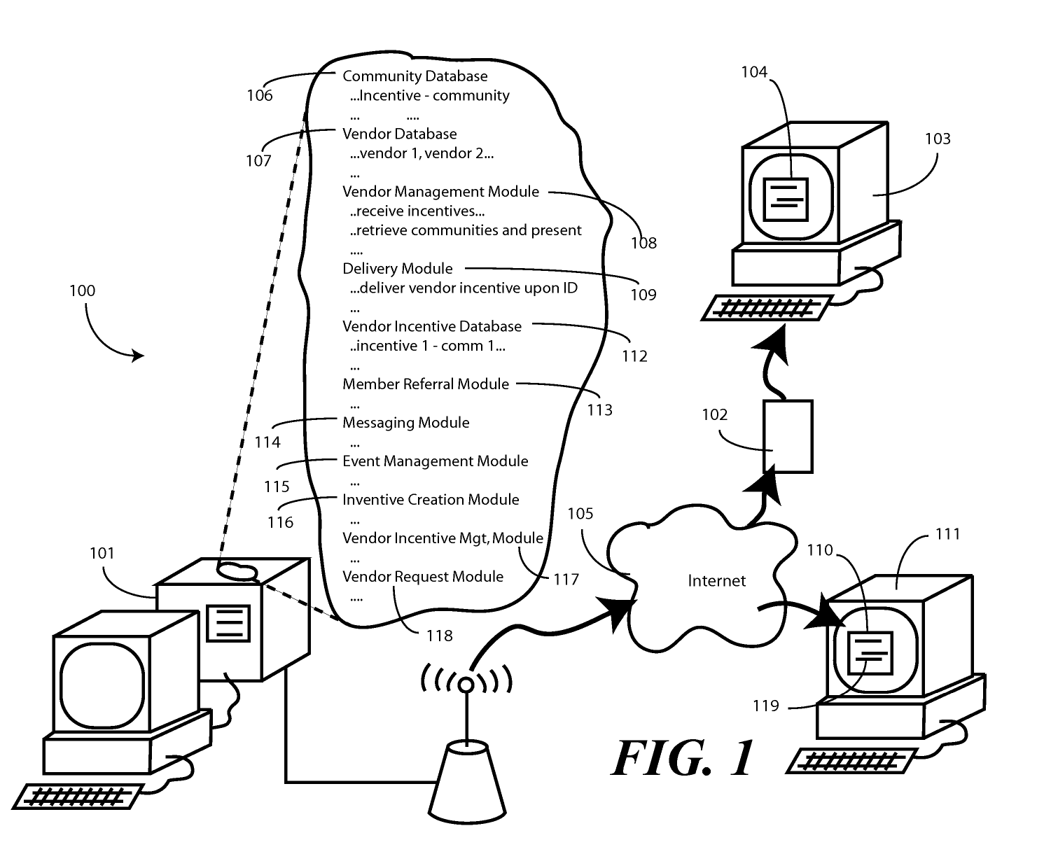

Turning now to FIG. 1, illustrated therein is one embodiment of a system 100 for delivering an incentive to a predetermined group of consumers in accordance with the invention. A server 101 is configured to deliver browser readable content 102 to a client terminal 103 having a networked interface portal 104, such as an Internet or Web browser, that is in communication with a network 105. In one embodiment, the server 101 is a file server and associated processing components configured to deliver a web page to a personal computer coupled to the Internet. It will be clear to those of ordinary skill in the art having the benefit of this disclosure, however that the invention is not so limited. Other servers, including those configured to deliver media content to portable devices, such as mobile telephones and personal digital assistants, may also be employed. Additionally, while the client terminal 103 is a computer in the illustrative embodiment of FIG. 1, portable computers, mobile telephones, personal digital assistants, and kiosks could equally serve as client devices.

The server 101 has access to a community database 106. The community database 106 has stored therein a plurality of communities. Each community has associated therewith as members a group of consumers having at least one common association characteristic. For example, all the employees of a particular employer have that as a common association characteristic. Similarly, all the alumni of an educational institution have that as a common association characteristic. A community can be any organization that has an organizational structure associated therewith. As will be described below, in one embodiment of the invention, vendors may deliver incentives such as promotions and coupons to a particular community or communities. Each community has a unique community identifier associated therewith, which is used to access a community portal. The members of each community may be advised of the unique community identifier through their organization's organizational structure. This may be more easily explained with the following example.

Suppose employer X wants its employees to have access to special promotions from local retailers, businesses, or service providers. As such, when using a method or system in accordance with embodiments of the invention, that employer contacts a purveyor of the system to have its employees established as a community, with its employees as members. The purveyor of the system may then store employer X in the community database 106. The employees will then be members of this community. The purveyor then assigns a unique identifier to the community. The employer, using its organizational structure, may then relay the unique identifier to its members. Suitable organizations for communities include schools, employers, religious organizations, family organizations, recreational organizations—such as sporting leagues, hobby organizations, and the like. This list is intended to be exemplary only, as other organizations will be evident to those of ordinary skill in the art having the benefit of this disclosure.

A vendor database 107 has stored therein a plurality of vendors who are approved to use the systems and methods of the invention. In some embodiments, it is desirable to pre-approve vendors for use with the system. As will be described below, some embodiments include vendor features, including incentive creation tools. A purveyor of the system may want to limit access to such tools by assigning a unique vendor identifier to each vendor upon approval. Further, vendor approval may be required to ensure that vendor products and services are congruent with the needs and wants of each community. For example, maternity clothes may not be suitable for a senior men's golf league.

A vendor management module 108, which may comprise executable software code operable with the server 101, is configured to receive a vendor incentive from a vendor in the vendor database 107. When vendors use the system, as will be described in more detail below, in one embodiment, they are able to select one or more communities to which their incentive, which may be limited in duration, is to be delivered. The vendor management module 108 retrieves the plurality of communities from the community database 106 and presents them to the vendor, for example through a vendor interface portal 110 on a vendor client terminal 111. As such, in one embodiment, when the vendor management module 108 receives the incentive from the vendor, the incentive will correspond to at least one target community from the group of communities stored in the community database 106.

Once the vendor management module 108 receives incentive from the vendor, the inventive may be stored in a vendor incentive database 112. The vendor incentive database 112 has stored therein the various vendor incentives received by the vendor management module 108 for delivery to the various communities. Within the vendor incentive database 112, each vendor incentive may be associated with one or more target communities.

A delivery module 109 is configured to retrieve applicable vendor incentives from the vendor incentive database 112 and to deliver the applicable vendor incentive to the target community or communities. In one embodiment, the delivery module 109 delivers the vendor incentive only to those target communities selected by the vendor. This occurs as follows: Where the vendor incentive corresponds to a target community, the server 101 will make the vendor incentive available to the target community after a member of the target community enters the unique community identifier in the networked interface portal 104.

A vendor request module 118 is operable with the server to permit members of the various communities to request vendors. For instance, if a popular restaurant in the area is not affiliated with a system in accordance with the invention, a member may access the networked interface portal 104 to request that the vendor become affiliated. The vendor request module 118 is configured to receive vendor requests from members when submitted. The vendor request module 118 may in turn forward the vendor request directly to the vendor, perhaps by e-mail or fax. Alternatively, the vendor request module 118 may store the received vendor request in memory for access by a customer service representative, who may then contact the vendor.

A member referral module 113 is operable with the server 101 and is configured to facilitate a referral of the various vender incentives from a first community to a second community. Such a module is useful, for example, when a vendor is not certain which communities may be interested in a particular service. For instance, where the vendor is a local delicatessen, the vendor may select as target communities businesses within a three-mile radius in an effort to promote a lunch special. One of those businesses may be hosting another business from out of town, and may wish to refer an incentive, such as a coupon or lunch special, to the other community. Where this is the case, the member referral module 113 facilitates this member-member referral between and among communities.

In another embodiment, the member referral module 113 is operable with the server 101 to facilitate a referral of the system to communities not affiliated with the system. For instance, where a member of a community having access to the system by way of the unique identifier is enjoying use of the system, that member may employ the member referral module 113 to notify others not affiliated with the system to become affiliated.

A messaging module 114 is configured to facilitate communication between members of a particular community. Upon entry of the unique community identifier, a member of a particular community may see many vendor incentives. In some situations, time constraints may prevent the member from browsing through each and every incentive. However, when the member finds a particularly attractive vendor incentive, the member may wish to send a message to another member saying something like, “Hey, I just noticed a really good deal on white-wall radial tires. Have you seen this?” The messaging module 114 facilitates such an intra-community message from one portal to another.

An event management module 115 is operable with the server 101 to facilitate the notification of events from communities to vendors. By way of example, where a community is having a large event, such as a party or picnic, the community may wish to notify suitable vendors, such as caterers, that the event is going to occur. The event management module 115 receives event notices from an event-hosting member of a particular community and delivers the event notice to one or more vendors. The event management module 115 may allow the event-hosting member to selectively choose the particular businesses. Alternatively, the event management module 115 may streamline the process by allowing the event-hosting member to choose a plurality of vendors, perhaps by category.

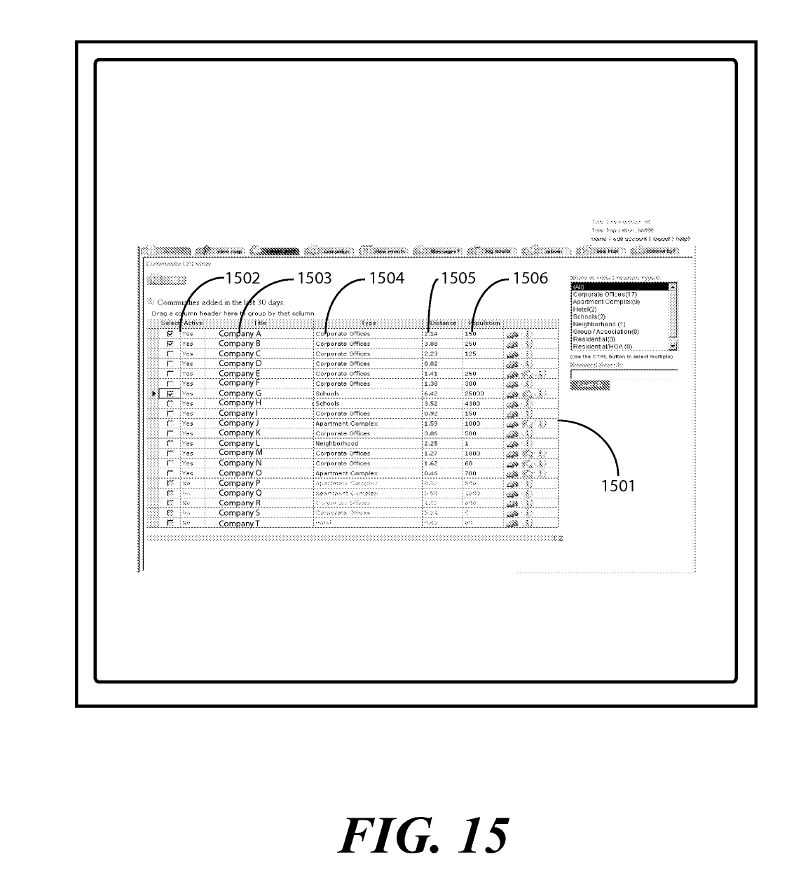

An incentive creation module 116 is accessible by vendors through the vendor client terminal 111 upon entry of the unique vendor identifier. While described in more detail below with respect to FIGS. 15-17, the incentive creation module is a simple tool with which vendors may create customized incentives for communities. The incentive creation module 116 may include a community selection tool, an advertisement creation tool, and, where the incentive is expiratory as is the case when the incentive is a coupon, an incentive duration tool.

A vendor incentive management module 117 is operable with the server 101 to allow the vendors to manage current and existing incentives. In one embodiment, the vendor incentive management model 117 is configured to present web browser readable content 119 on the vendor interface portal 110 in one or more views. A chronological view shows incentives in a temporal view, while a list view may show incentives in a tabular view. The vendor incentive management module 117 allows the vendor to quickly and easily access existing incentives.

The members of the various communities are able to access the vendor incentives by way of the networked interface portal 104. As noted above, one example of such a networked interface portal 104 is a Web browser operating on a personal computer. Thus, as an illustrative embodiment, the browser readable content 102 delivered by the server 101 in conjunction with the various modules described in the following figures will be that of Web pages. It will be clear to those of ordinary skill in the art having the benefit of this disclosure, however, that the invention is not so limited. The browser readable content 102 could take alternate forms, including content configured for portable devices, content configured for kiosks, or content configured for home informational systems.

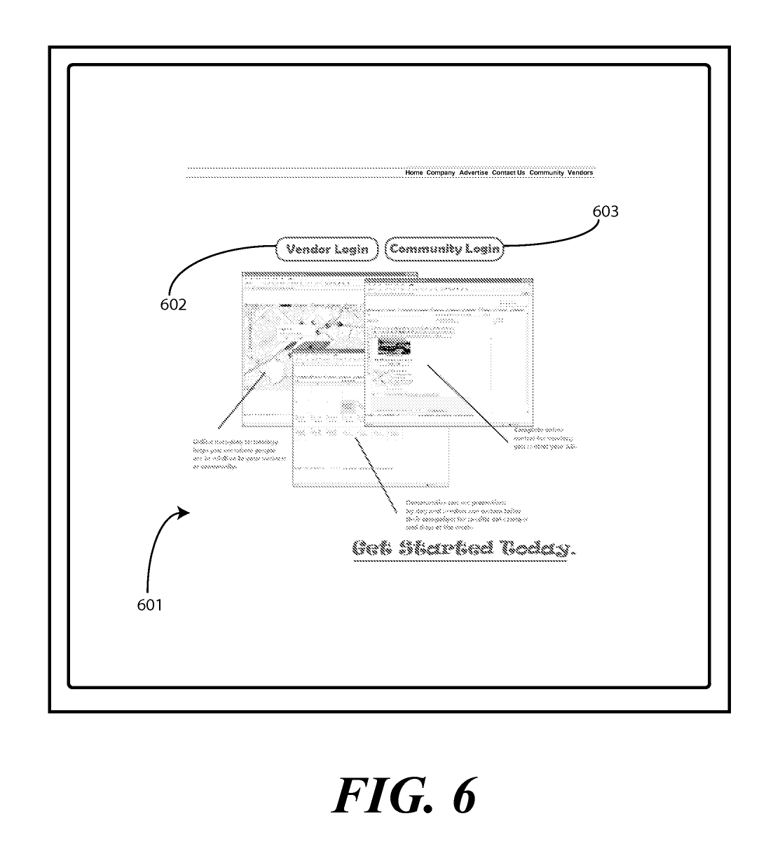

Turning now to FIG. 6, illustrated therein is one example of browser readable content (102) where the browser readable content (102) is a system welcome page 601. In the illustrative embodiment of FIG. 6, the system welcome page is a general page greeting those accessing the system. The system welcome page 601 includes a vendor portal access link 602 and a community portal access link 603. Vendors select the vendor portal access link 602, while community members select the community portal access link.

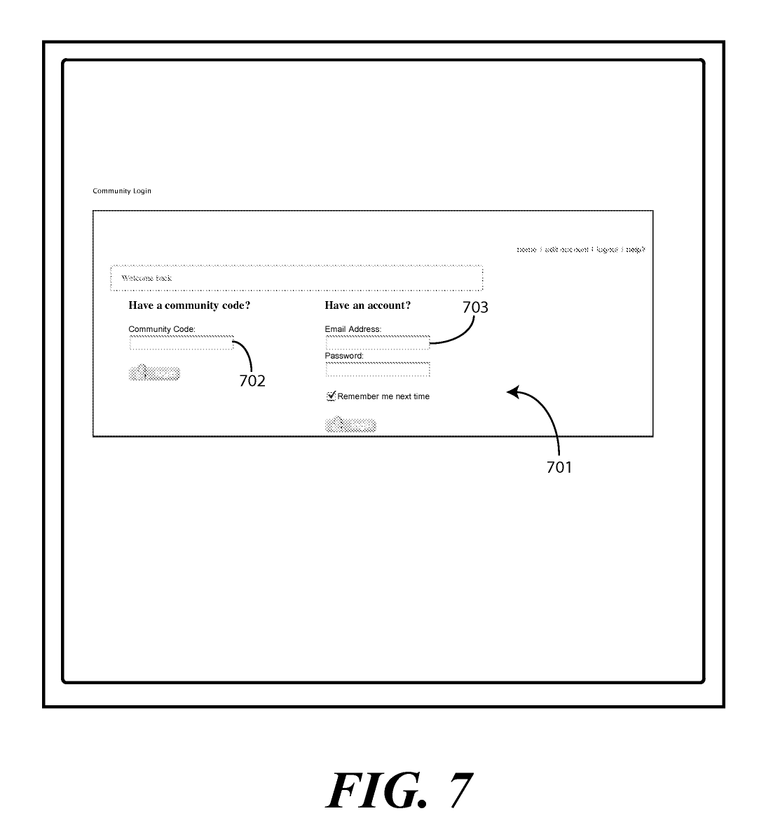

Turning now to FIG. 7, illustrated therein is one example of browser readable content (102) where the browser readable content (102) is a member interface 701. The member interface 701, shown here as a Web page, is an interface through which members of various communities may access their vendor incentives. The member interface 701 is accessible by members of various communities upon entry of a unique community identifier. This unique community identifier is entered via a unique community identifier portal 702. In one embodiment, all that is needed to access vendor incentives is the unique community identifier. In such an embodiment member confidentiality is protected, as personal information is not required to enter the system.

While the member need only enter the unique community identifier in the unique community identifier portal 702 to access incentives, in one embodiment, the member is able to access additional services by creating an account. The member accesses the account 703 by way of the account access portal 703. Account creation offers members a way to establish uniqueness in their system experience. By way of example, the member may be able to customize the various views.

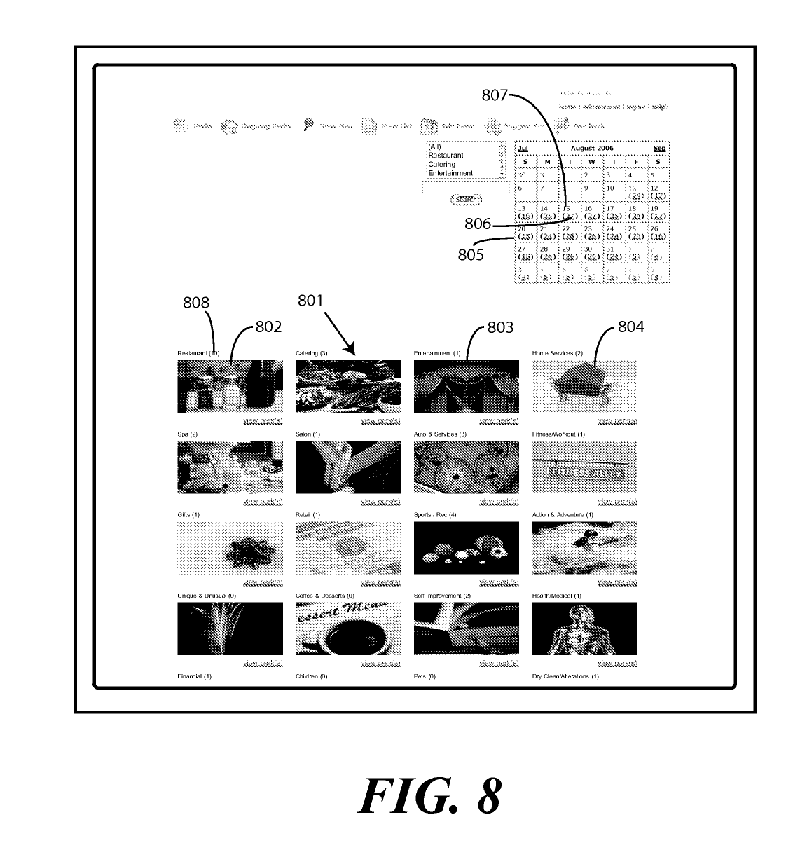

Upon entry of the unique community identifier, a community member is permitted to view vendor incentives directed to the community with which the member is affiliated. Turning now to FIG. 8, illustrated therein browser readable content (102) accessible to the member upon entry of the unique community identifier, where the browser readable content (102) is a categorical view 801 of a plurality of vendor incentives. As shown in FIG. 8, the various vendor incentives are organized by category, with one illustrative category being vendor business type.

By way of example, a first category 802 corresponds to restaurants, while a second category 803 corresponds to entertainment, while a third category 804 corresponds to home services. The number of vendor incentives, e.g. the number shown at 808, may also be displayed. Where the categorical view 801 is embodied in an interactive format, for instance a Web page, each categorical listing may serve as a live link to the various vendor incentives associated with that category. In one embodiment, clicking on the live category link may take the member to a list of vendors within that category. From this list, the member may select a particular vendor and view associated incentives.

FIG. 8 also illustrates browser readable content (102) where the browser readable content (102) comprises a chronological view 805. As noted above, examples of some vendor incentives are coupons which are expiratory in nature. Further, certain vendors may wish to present a “deal of the day” or coupons that are valid only for special occasions. To facilitate a simple way for community members to view such incentives, the browser readable content (102) may be arranged in the chronological view 805. In one embodiment, the chronological view 805 is displayed as a calendar, with a number of incentives, e.g. number 806, linked to each day. By clicking on a day, where the chronological view is interactive, a community member may view incentives that are active for any one particular day.

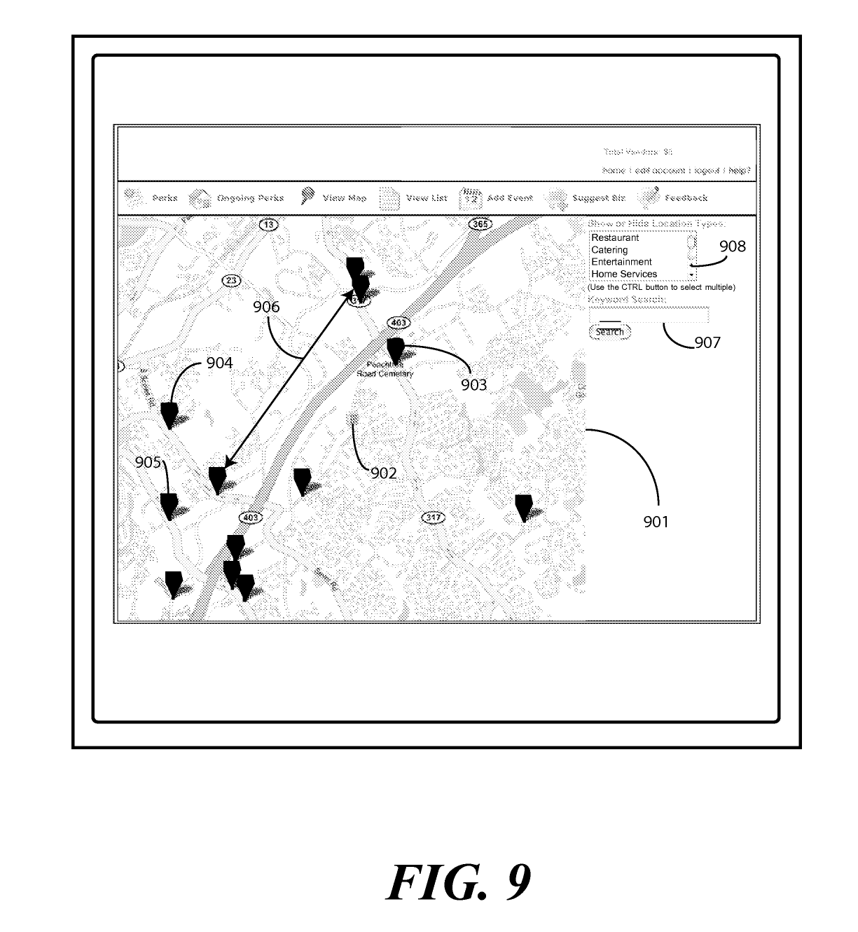

Turning now to FIG. 9, illustrated therein is one example of community browser readable content (102) where the browser readable content (102) comprises a geographical view 901 of vendors. A community member may be interested in a type of vendor, for example a restaurant, but may not desire to drive across town. To serve this type of member, in one embodiment, the server (101) delivers a geographical view 901 of vendors depicted as a map having vendors, e.g. vendor 903, vendor 904, and vendor 905, arranged in a spatial presentation 906 with respect to the community 902. Thus, each community member may easily view the location of the vendor prior to selecting a corresponding incentive.

In one embodiment, the member may change the geographical view 901 by using either the keyword search portal 907 or vendor type selector 908. The vendors displayed on the geographical view 901 may be only a subset of vendors, as showing all possible vendors may unnecessarily clutter the view. To assist in focusing the geographic view 901 only on desired vendors, the member may type a keyword in the keyword search portal 907. By way of example, the member may type “chicken” in the keyword search portal 907 to find chicken restaurants in the area. The geographic view would then update accordingly. Similarly, the member may select a category in the vendor type selector, to correspondingly update the geographical view 901. Note that many views described here, including those of FIGS. 8, 10, 14, 15, and 19, utilize the keyword search portal 907 and type selector 908 in a similar fashion.

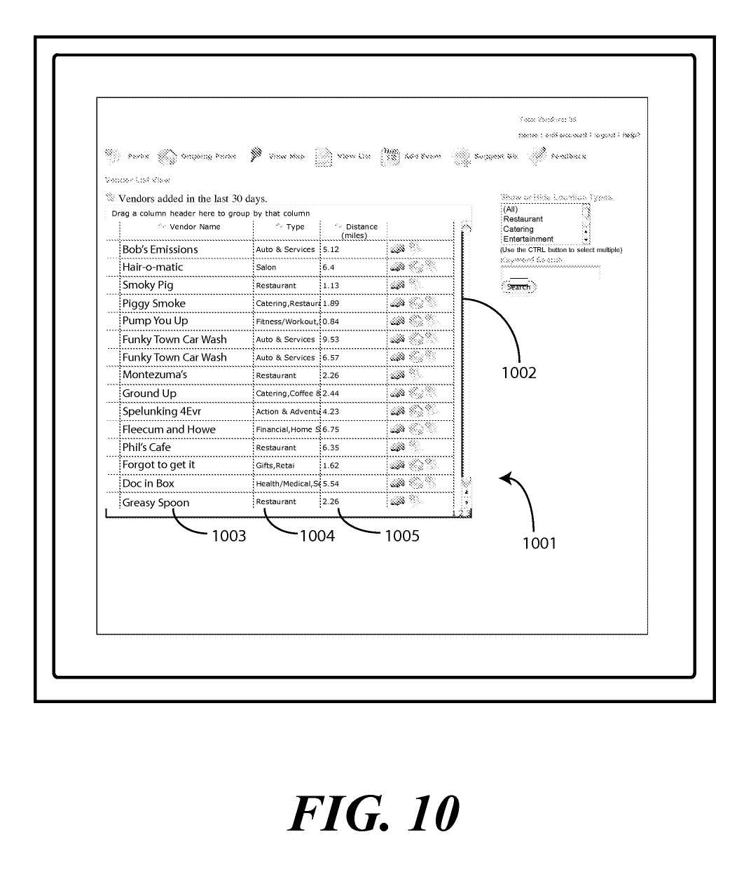

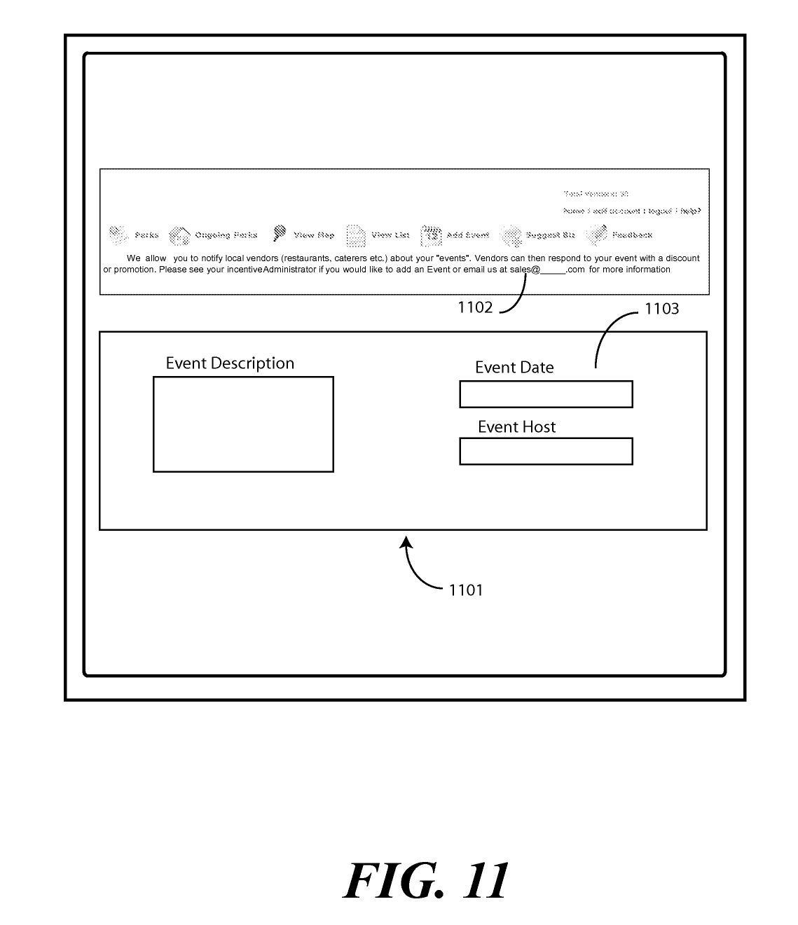

Turning now to FIG. 10, illustrated therein is one example of community browser readable content (102) where the browser readable content (102) comprises a tabular view 1001 of a plurality of approved vendors. A community member using a system or method in accordance with the invention may find it desirable to view all vendors in a sortable fashion, such as in a list 1002. Each vendor, e.g. vendor 1003, may be shown in the list 1002 with at least one vendor characteristic. For instance, two vendor characteristics shown in the illustrative embodiment of FIG. 10 are vendor type 1004 and vendor distance 1005 from a querying community. With the tabular view 1001, the querying member may sort vendors by name, or by vendor characteristic to find a suitable vendor.

Turning now to FIG. 11, illustrated therein is one example of community browser readable content (102) where the browser readable content (102) is facilitated by the event management module (115). The browser readable content (102) comprises an event management view 1101. The event management view 1101 serves as a portal through which members of communities may announce specific events. The event management view 1101 may facilitate reception of events in a variety of ways. In one embodiment, the event management view 1101 may include contact information 1102 with which a community member may contact a service representative. This may be desirable when, for example, the community member needs help in determining to which vendors the event notice should be transmitted. In another embodiment, the event management view 1101 may include an event entry portal 1103 with which a member may submit event details to the event management module (115) for delivery to vendors.

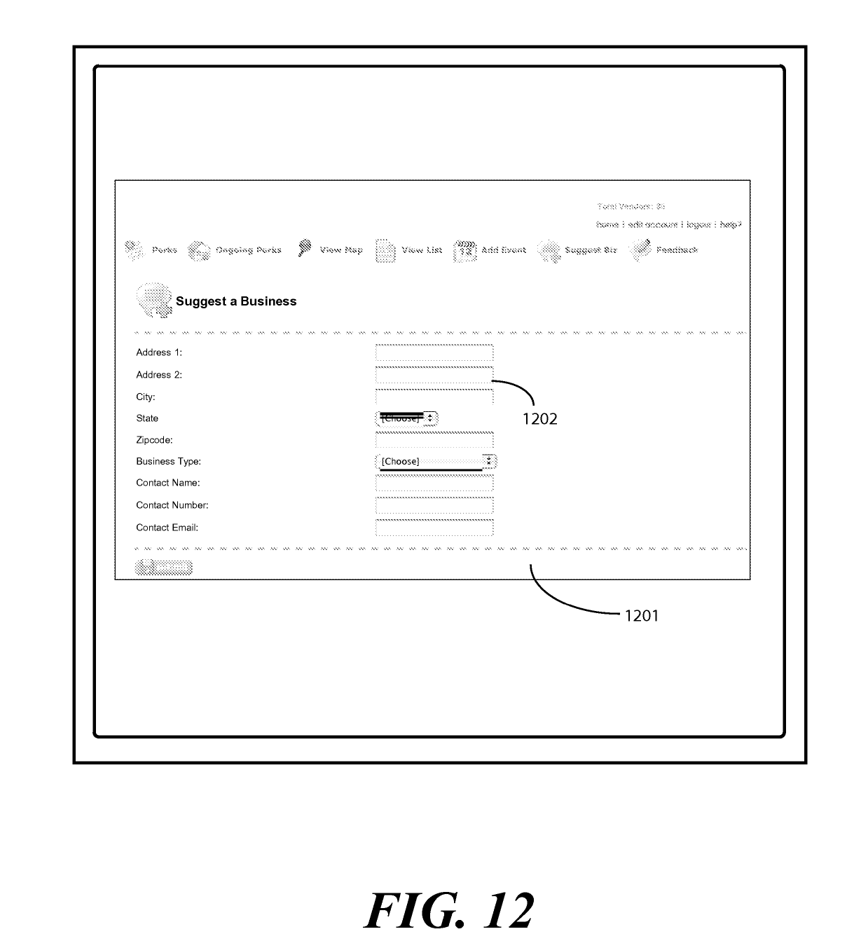

Turning now to FIG. 12, illustrated therein is one example of community browser readable content (102) where the browser readable content (102) is facilitated by the vendor request module (118). The browser readable content (102) comprises a vendor request view 1201. With the vendor request view 1201, a member may submit identifying information about a vendor through a vendor request information portal 1202. This information is then delivered to the vendor request module (118) for action by either a customer service representative or an automated delivery process.

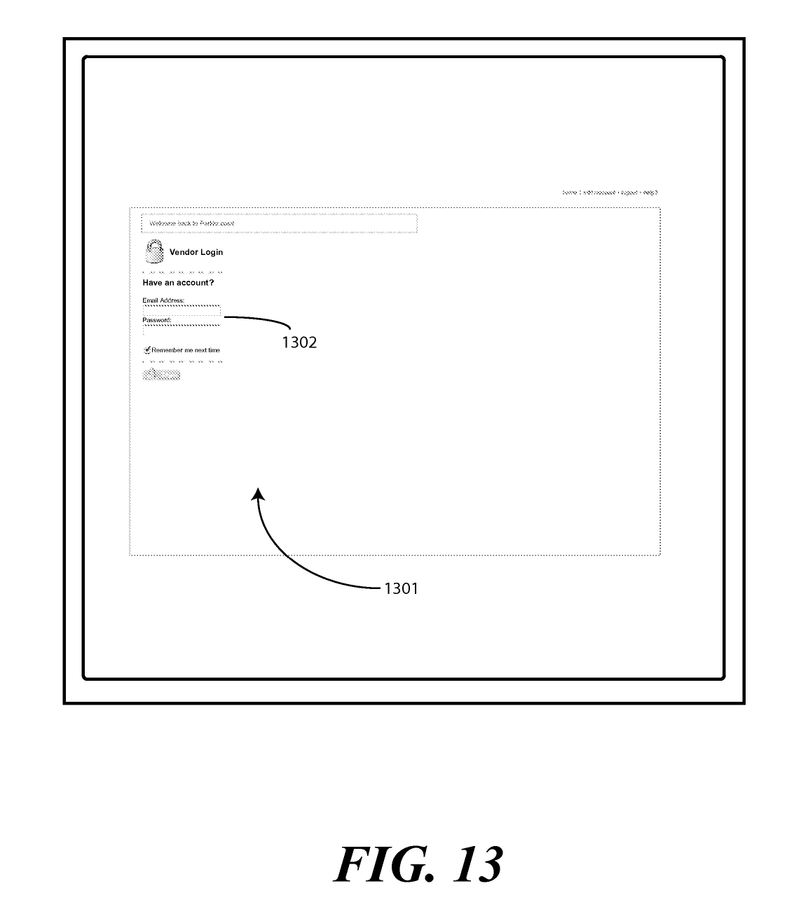

Just as community members may access a community interface portal, so too can vendors access a vendor interface portal. Turning now to FIG. 13, illustrated therein is one embodiment of a vendor interface 1301 accessible to the vendor upon entry of a vendor identifier. The vendor identifier, which may be a unique vendor identifier or a more common identifier such as an e-mail address and password, may be entered through a vendor identifier portal 1302 on the vendor interface 1301.

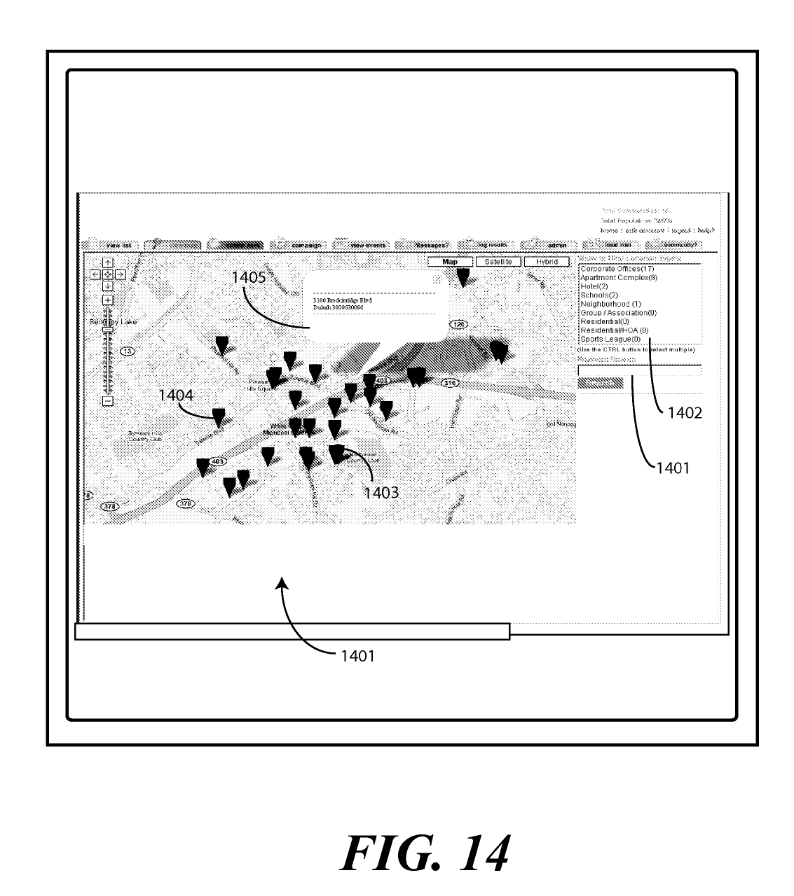

Upon entry of the vendor identifier the vendor may be directed to one of a variety of views and tools within the vendor interface portal. Turning now to FIG. 14, illustrated therein is one such view. FIG. 14 illustrates a geographical view 1401 of communities accessible to the vendor. The geographical view 1401 may be a subset of the available communities, perhaps as selected by the location type selector 1402. Similarly, a keyword search 1406 may be used as described above with respect to FIG. 9. Various communities, for example community 1403 or community 1404, are shown spatially relative to a specific geographic location. Where the geographical view 1401 is interactive, for instance where the geographical view 1401 is a Web site, one embodiment of the invention allows the vendor to view additional information 1405 about any one particular community by hovering over that community indicator.

Turning now to FIG. 15, illustrated therein is an alternate view accessible by a vendor. The view of FIG. 15 is a tabular view 1501 of communities available for incentive targeting. In one embodiment, the tabular view 1501 includes a selector column 1502 with which a vendor may select communities to add to new or existing incentive campaigns. Additionally, a community identifier column 1503 identifies each community. A community type column 1504 provides the type of community, while a distance column 1505 shows the distance of the community from the vendor. A population column 1506 shows the number of members in each community. Where the tabular view 1501 is interactive, the vendor may sort any of the columns 1503,1504,1505,1506 to easily access the target community of choice.

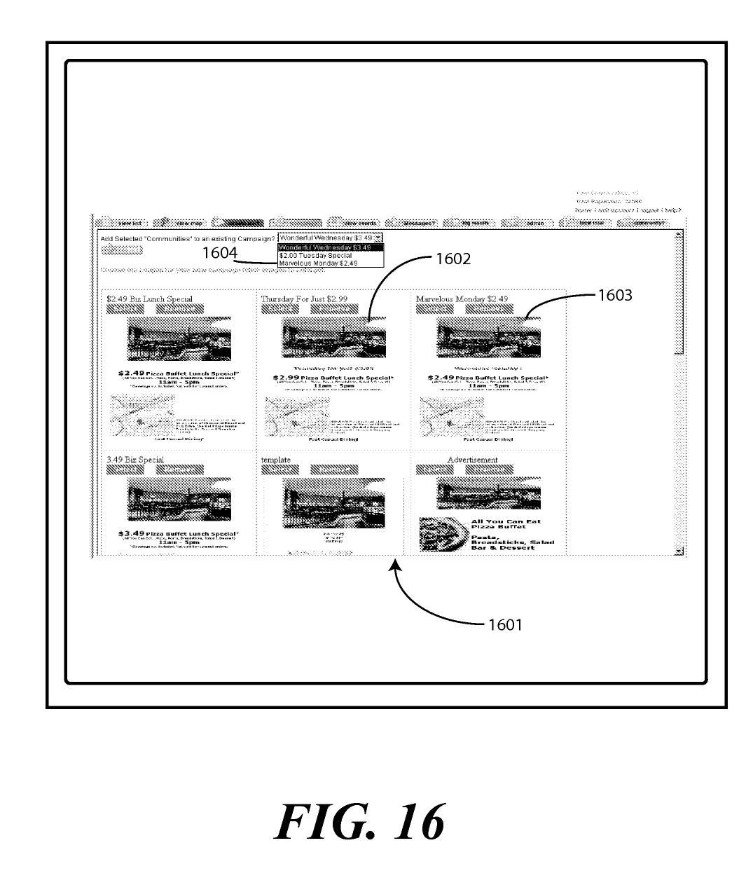

Turning now to FIG. 16, illustrated therein is a promotional management view 1601 accessible by vendors. The promotional management view 1601 provides the vendor with quick access to existing promotions, e.g. promotions 1602 and 1603. Additionally, the promotional management view 1601 provides the vendor with an existing campaign portal 1604 with which the vendor may access existing incentive campaigns, for promotion to additional communities.

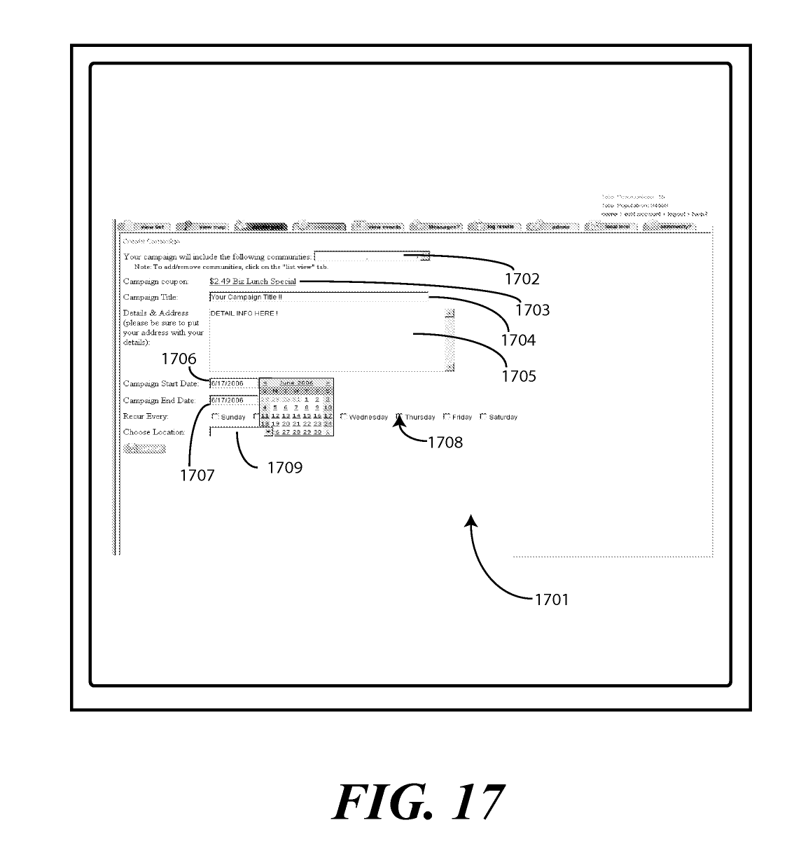

Turning now to FIG. 17, illustrated therein is one embodiment of an incentive creation portal 1701, as may be facilitated by the incentive creation module (116). Where employed, the incentive creation portal 1701 provides a vendor with a simple and quick tool to create various types of incentive campaigns. In the exemplary embodiment of FIG. 17, the incentive creation portal 1701 includes a community selection portal 1702 with which a vendor may view selected target communities to whom the incentive will be delivered. These communities are selected in FIG. 15. An incentive selection identifier 1703 identifies the incentive to be delivered. Such incentives may be those found in the view of existing promotions displayed in FIG. 16.

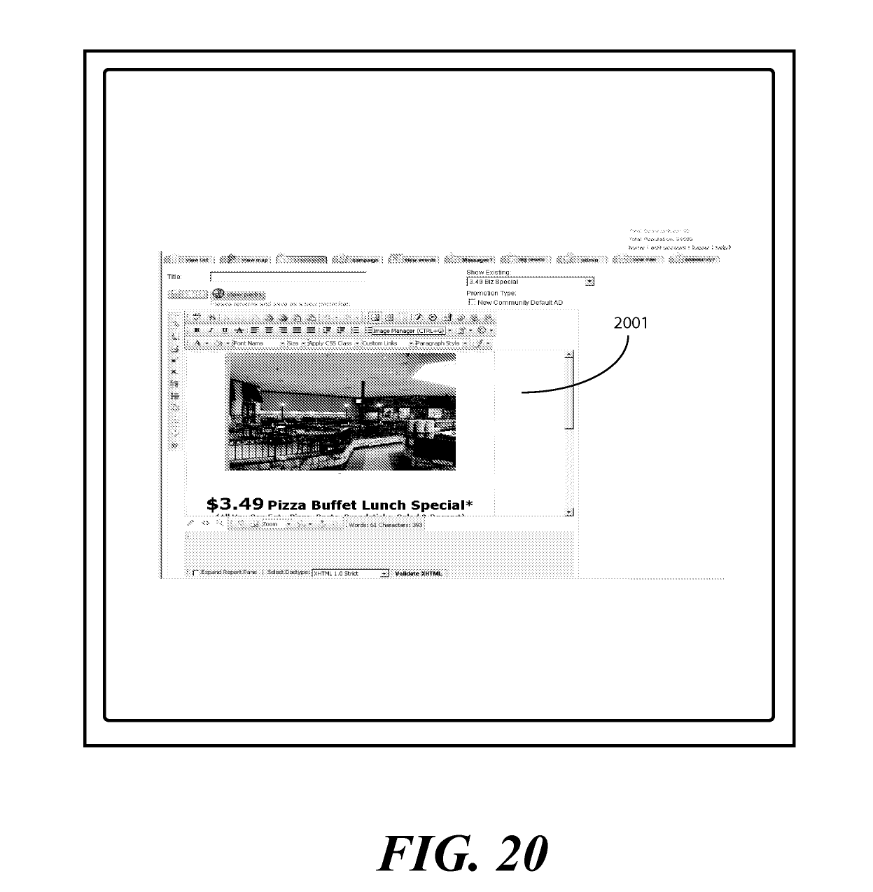

Turning briefly to FIG. 20, illustrated therein is an incentive creation tool 2001 that may be optionally provided to the vendor for the creation of incentives. The incentive creation tool 2001, allows a vendor to easily upload photos and text, as well as arrange content, to create an incentive. In one embodiment, the incentive creation tool 2001 is a hypertext mark-up language (HTML) editor. The incentive creation tool 2001 could equally be an editor equipped to handle video, audio, and other types of interactive media. In another embodiment, the incentive creation tool includes selectable templates from which vendors may create incentives.

Turning back to FIG. 17, an incentive title portal 1704 allows the vendor to give the incentive a name. Some vendors may choose to include community specific names, such as the “Super Business X Lunch Special” or “Hot Deal for Company Y”. An incentive description portal 1705 provides the vendor the opportunity to enter a detailed description of the terms and conditions, where applicable, of the incentive. An incentive duration portal includes an incentive start date portal 1706 and an incentive end date portal 1707, with which the vendor may establish the duration of the incentive. Such a portal is useful where the incentive will be expiratory in nature, as is the case with some coupons. An incentive repeat portal 1708 allows the vendor to designate specifically repeating events, such as would be the case when the vendor desires the incentive to appear only every Monday, for example. The incentive creation portal 1701 may also include a location selection portal 1709 where, for instance, a vendor with multiple locations may select the location honoring the incentive.

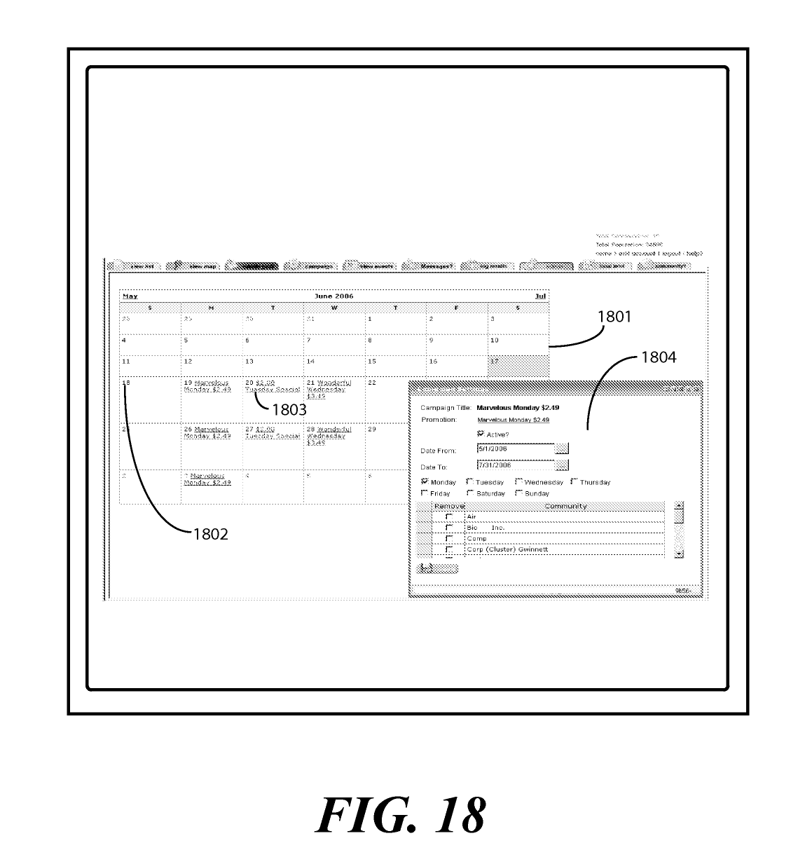

Turning now to FIG. 18, once the incentive has been created, a chronological view 1801 of the vendors incentives includes a calendar 1802 with which the vendor may view active incentives on a temporal basis. The calendar 1802 provides a quick and simple way for the vendor to view an active incentive, e.g. incentive 1803, on a given particular day. Thus, the vendor may easily determine when certain incentives overlap, or date spans where no incentives exist. The chronological view 1801 provides a useful organizational tool for incentive management. Where the chronological view 1801 is interactive, the vendor may click on a particular incentive 1803 to bring up a detailed incentive view 1804.

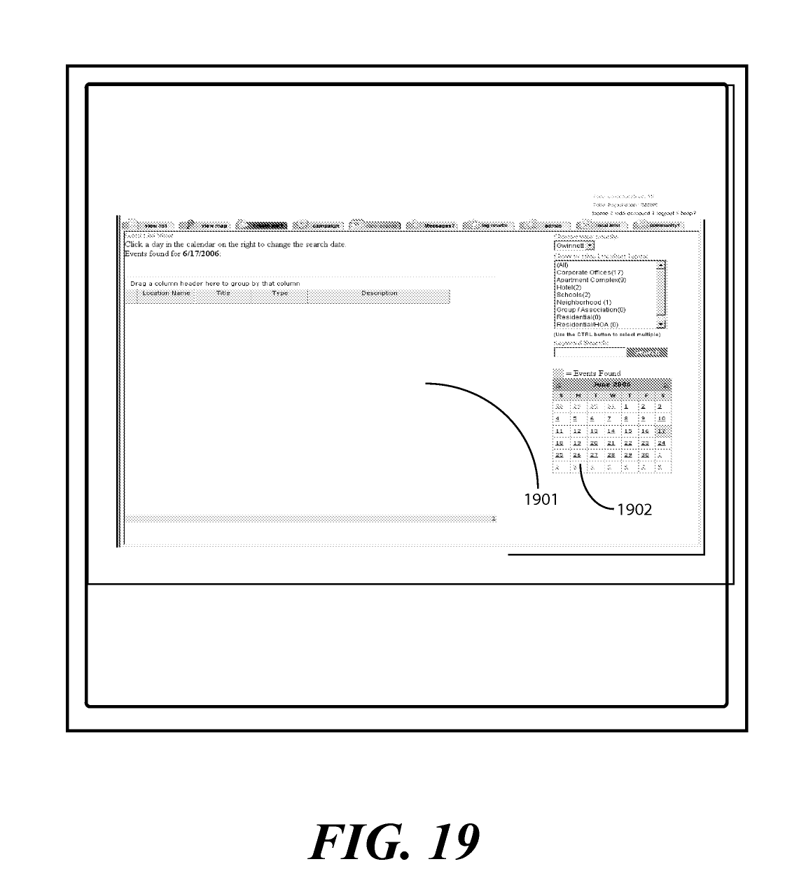

Turning now to FIG. 19, illustrated therein is an active event view 1901 that is accessible by the vendor. The active event view 1901 provides a way for the vendor to view events received from community members as facilitated by the event management module (115). Upon viewing active events in the active event view 1901, the vendor may select for which events he would like to submit incentives. Upon selecting a particular event, the vendor may then turn to the incentive creation module (FIG. 17) to create that particular incentive.

The vendor may select events to view by date with the calendar selector portal 1902. By selecting a date in the calendar selector portal 1902, posted events for that date only will be presented in the active event view 1901.

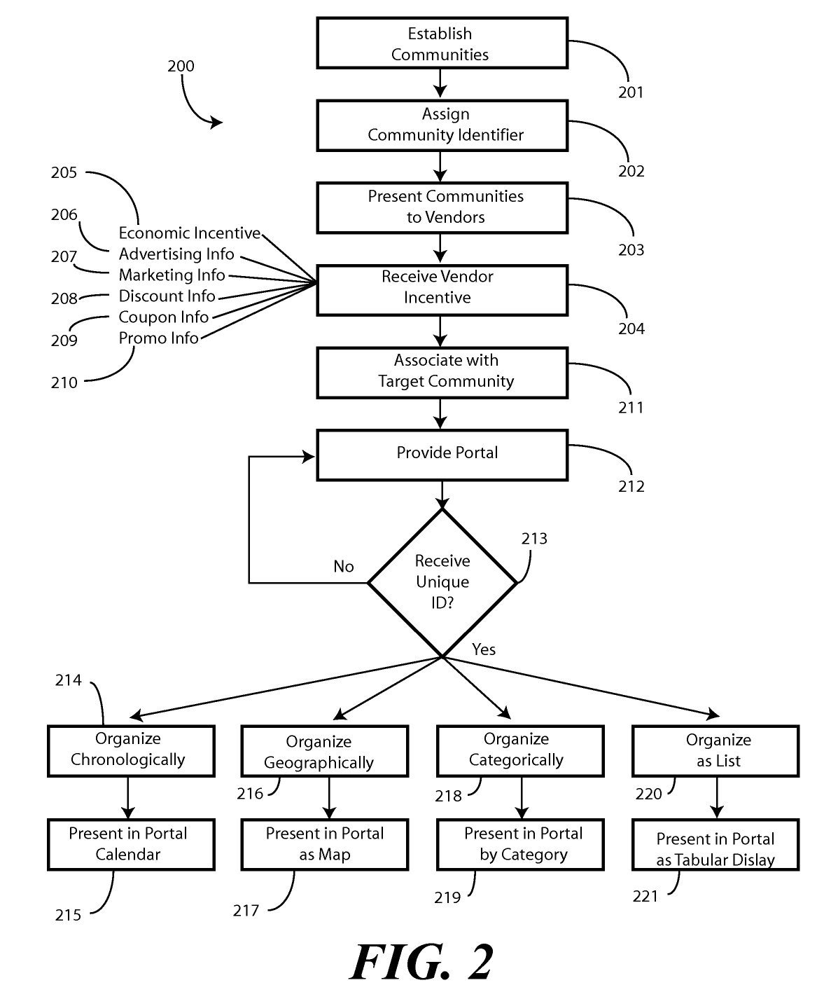

Now that the various modules and views have been described, embodiments of methods will be examined in more detail. Turning first to FIG. 2, illustrated therein is one embodiment of a method 200 for delivering an incentive from a vendor to a plurality of consumers in accordance with the invention. At step 201, the communities are established. The system establishes communities by defining communities as being groups of consumers with at least one common association characteristic. Each community of the plurality of communities established has associated therewith as members a plurality of consumers. Once these communities have been defined, they may be stored in the community database (106) for access by the server (101).

At step 202, a unique community identifier is assigned to each community. This unique community identifier may be delivered to the central organization of the community for dissemination to the members through the organization's communication system, as a community in one embodiment includes an organization having communication capabilities with the constituents of the organization. The unique identifier may be used by the community members to access vendor incentives through the community networked interface portal (104).

At step 203, the system presents the communities to at least one vendor. This may be done, for example, through the geographical view (1401), the tabular view (1501), or the community selection portal (1702). Where the vendor desires to provide an incentive targeted to one of the communities, the system receives the vendor incentive at step 204. The vendor incentive received at step 204 includes at least one target community corresponding to the vendor incentive. Of course, a vendor may target the incentive to more than one community. Further, as noted above, the incentive may include, but is not limited to, an economic incentive (205), advertising information (206), marketing information (207), discount information (208), coupon information (209), or promotional information (210).

At step 211, the system may associate the vendor incentive with at least one community that corresponds to the target community in the vendor incentive database (112). Once properly associated, the system may deliver the incentive, for example by way of the community networked interface portal (104) provided at step 212, to the target community. In one embodiment, the system makes the incentive accessible only to the target community. The target community accesses the incentive by entering a unique community identifier, which the system confirms at decision 213. Upon accessing the community networked interface portal (104), the members may access the vendor incentive.

The incentive may be presented to the community in a variety of ways. At step 214, the system organizes the various incentives chronologically. The incentive may then be presented, perhaps in a chronological view (805) or display at step 215.

Alternatively, the vendors having active incentives available to a target community may be organized geographically at step 216. Members of communities may then access incentives by selecting vendors from a geographical view (901), presented at step 217. The geographical view (901) or geographical display may include a map having geographical indicia corresponding to the at least one vendor.

In one embodiment, the active vendor incentives are organized categorically at step 218. This categorical organization may include a grouping by business type. Once so organized, the vendors and incentives may be displayed as a categorical view (801) at step 219, where the vendors are displayed according to business type or category.

In another embodiment, the vendors or incentives may be organized in a list at step 220. This list may then be displayed as a tabular view (1001) at step 221.

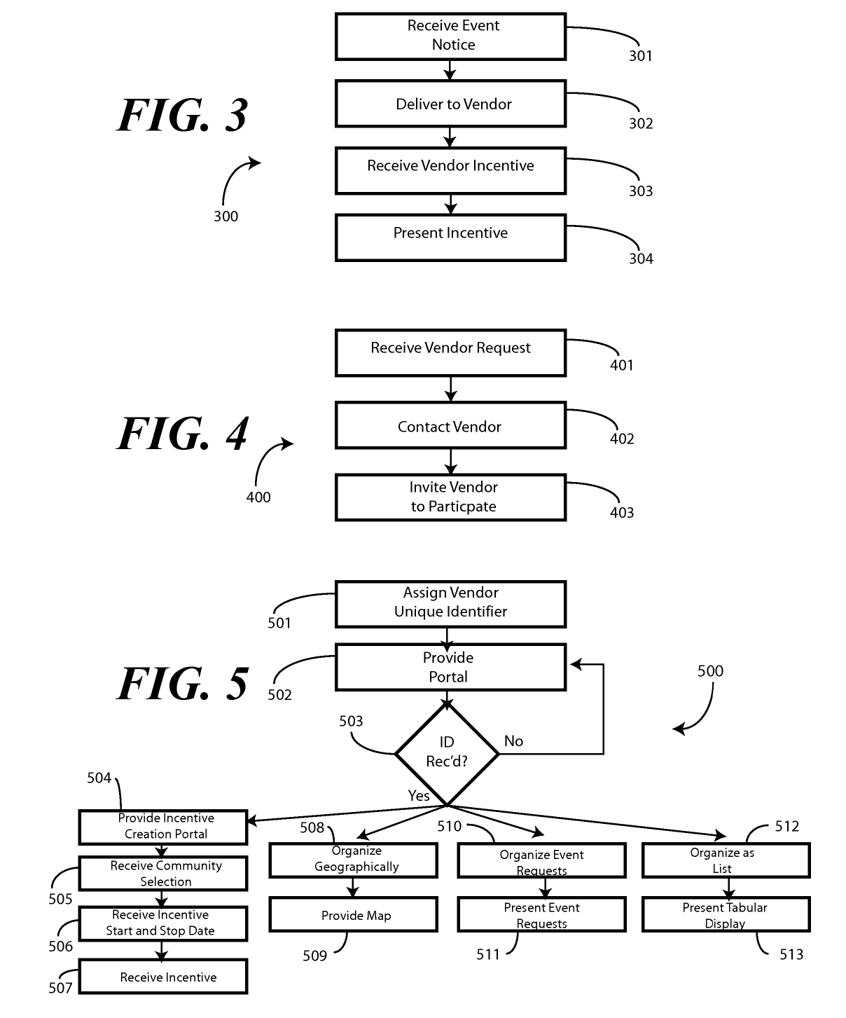

Turning now to FIG. 3, illustrated therein is one embodiment of a method 300 for facilitating the direction of event notices from community members to vendors in accordance with the invention. Such a method 300 is suitable for use, for instance, by the event management module (115).

At step 301, a community event notice is received from a member of an event-hosting community. At step 302, the community event notice is delivered to one or more suitable vendors. As noted above, this step of delivery may be performed by a customer service representative of a purveyor of this method. Alternatively, the step may be performed automatically by the event management module (115). p At step 303, where a vendor elects to provide an incentive corresponding to the event, the incentive is received. At step 304, the incentive is presented to the event-hosting community.

Turning now to FIG. 4, illustrated therein is one embodiment of a method 400 for facilitating vendor requests in accordance with the invention. Such a method is suitable for use, in one embodiment, by a vendor request module (118). At step 401, a vendor request is received from a requesting member of one of the communities. In one embodiment, the vendor request module (118) receives such a vendor request from a vendor request view (1201). At step 402, the requested vendor is contacted. At step 403, an invitation is delivered to the requested vendor. The invitation may include a request for incentives from the vendor for the requesting community. As with the event manager, the invitation may be delivered either by a customer service representative of a purveyor of the method, or automatically by the vendor request module (118).

Turning now to FIG. 5, illustrated therein is one method 500 for accommodating vendors in accordance with embodiments of the invention. To permit vendors to access the system, in one embodiment, at step 501 a unique vendor identifier is assigned to the vendor. The unique vendor identifier may be an e-mail address and password or a unique string identifier assigned by the system. At step 502, a networked vendor interface portal, accessible to the vendor upon entry of the unique vendor identifier detected at decision 503, is provided so that the vendor may create and upload incentives, select target communities, and manage existing incentive programs.

Once the vendor has accessed the interface portal, in one embodiment an incentive creation portal (1701), optionally combined with an incentive creation tool (2001), is provided at step 504 to the inventor for creating incentives and incentive programs. In one embodiment, like that shown in FIG. 17, a community selector is provided with which the vendor may select at least one target community for a corresponding incentive. Where a target community is selected, the system, via a vendor management module (108) in one embodiment, receives the target community selection at step 505. An incentive duration, where the incentive is expiratory, may be received at step 506. The completed incentive is received at step 507.

To assist the vendor in community selection, in one embodiment the system, perhaps by way of a vendor incentive management module (117) organizes the communities stored with the community database (106) at step 508. The system may then present the geographically organized communities to the vendor by way of a geographical vendor interface display at step 509. In one embodiment, the geographical vendor interface display comprises a map having geographical indicia corresponding to the plurality of communities.

Where communities submit special events, for example through an event management module (115), the system organizes the event requests for delivery to the vendor at step 510. The system may present applicable events to the vendor with an event interface at step 511. In one embodiment, the event interface includes a community event notice from an event hosting community to which the vendor may respond with an event-specific incentive.

For ease of access, the system may simply organize communities and community characteristics in a tabular list at step 512. Where the tabular list is presented in an interactive fashion, perhaps as a vendor data interface display presented as a Web site, the vendor may sort communities by the corresponding characteristics, community names, distances, etc. The tabular list is presented at step 513. In one embodiment, the tabular list includes at least one community characteristic selected from the group consisting of community description, community distance, and community population. It will be clear to those of ordinary skill in the art having the benefit of this disclosure that the invention is not so limited. Other community characteristics, such as main community contact, community historical data with the vendor, and the like may also be presented.

As illustrated and described, embodiments of the invention offer a dynamic and interactive networked application that facilitates incentive delivery and communication between a group of vendors and one or more communities. Community members can access vendor information through a graphical user interface, such as a Web page, or through other devices, such as mobile phones and kiosks. The information may be presented to vendors in text, multimedia, or by audible means. Vendors may select communities, and communities may select incentives, search criteria such as but not limited to keyword, classifications, characteristics, location, distance, direction and type or other information.

A number of vendor incentives can be posted to a community's networked portal. These vendor incentives can be accessed by members of communities upon entry of a unique community identifier. Sometimes, vendor incentives will be temporal, and may be expiratory. To facilitate ease of access, in one embodiment active incentives may also be viewed through a chronologically arranged portal, such as a calendar.

Vendors may create specific incentives targeted to specific communities. Vendors may choose to create incentives in a “collaborative” status. If a vendor is in a collaborative status, it may create collaborative incentives with other vendors for community consumption. By way of example: If a pizza vendor is creating an advertising campaign he may want to collaborate with an ice cream vendor to offer a better promotion. Both vendors would collaborate and create and submit the incentive together.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for delivering an incentive from a vendor to a plurality of consumers, the method comprising the steps of:
a. establishing a plurality of communities, wherein each community within the plurality of communities has associated therewith as members a plurality of consumers having at least one common association characteristic;
b. presenting the plurality of communities to at least one vendor;
c. receiving a vendor incentive from the at least one vendor and at least one target community corresponding to the vendor incentive; and
d. making the vendor incentive accessible only to the at least one target community.

2. The method of claim 1, further comprising the steps of associating the vendor incentive with at least one community corresponding to the at least one target community, and delivering the vendor incentive by way of a networked interface portal.

3. The method of claim 2, wherein the vendor incentive is expiratory, further comprising the step of organizing the vendor incentive in a chronological display.

4. The method of claim 1, wherein the at least one common association characteristic comprises affiliation with an organization having communication capabilities with constituents of the organization.

5. The method of claim 1, wherein the incentive is selected from the group consisting of economic incentives, marketing information, advertising information, discount information, coupon information, and promotional information.

6. The method of claim 1, further comprising the steps of:
a. assigning a unique community identifier to the each community; and
b. providing a networked member interface portal, accessible by the members upon entry of the unique community identifier;
wherein upon accessing the networked member interface portal, the members may access the vendor incentive.

7. The method of claim 6, further comprising the step of providing a calendar interface display, accessible by the members, the calendar interface display comprising the vendor incentive.

8. The method of claim 5, further comprising the step of providing a geographical member interface display, accessible by the members, the geographical member interface display comprising a map having geographical indicia of the at least one vendor.

9. The method of claim 5, further comprising the step of providing a categorical interface display, accessible by the members, wherein the at least one vendor is displayed according to a corresponding business category.

10. The method of claim 1, further comprising the steps of:
a. receiving a community event notice from a member of one community of the plurality of communities; and
b. delivering the community event notice to the at least one vendor.

11. The method of claim 10, further comprising the steps of receiving from the at least one vendor a community event incentive corresponding to the community event notice, and presenting the community event incentive only to the one community of the plurality of communities.

12. The method of claim 1, further comprising the steps of receiving a vendor request for a requested vendor from a requesting member associated with one community of the plurality of communities, and delivering an invitation to the requested vendor for a community incentive associated with the one community of the plurality of communities.

13. The method of claim 1, further comprising the step of providing a member data interface display comprising a tabular list of the at least one vendor, with at least one vendor characteristic displayed therewith.

14. The method of claim 1, further comprising the steps of:
a. assigning a unique vendor identifier to the at least one vendor; and
b. providing a networked vendor interface portal, accessible by the at least one vendor upon entry of the unique vendor identifier.

15. The method of claim 14, further comprising the step of providing an incentive creation portal, accessible by the at least one vendor, the incentive creation portal comprising a community selector with which the at least one vendor may select the at least one target community.

16. The method of claim 15, further comprising the step of receiving at least an incentive start date and an incentive stop date from the at least one vendor via the incentive creation portal.

17. The method of claim 14, further comprising the step of providing a geographical vendor interface display, accessible by the at least one vendor, the geographical vendor interface display comprising a map having geographical indicia corresponding to the plurality of communities.

18. The method of claim 14, further comprising the step of providing an event interface, accessible by the at least one vendor, the event interface comprising at least one community event notice from at least one community of the plurality of communities.

19. The method of claim 14, further comprising a vendor data interface display comprising a tabular list of the plurality of communities, each of the plurality of communities having at least one community characteristic displayed therewith.

20. The method of claim 19, wherein the at least one community characteristic is selected from the group consisting of a community description, a community distance, and a community population.

21. A system for delivering an incentive to a predetermined group of consumers, the system comprising:
a. a server configured to deliver a browser readable content to a client terminal having a browser in communication with a network;
b. a community database operable with the server, the community database having stored therein a plurality of communities, each community having associated therewith as members a plurality of consumers having at least one common association characteristic;
c. a vendor database operable with the server, the vendor database having stored therein a plurality of approved vendors;
d. a vendor management module operable with the server to receive a vendor incentive from at least one vendor of the plurality of approved vendors, wherein the vendor incentive corresponds to at least one target community selected from the plurality of communities; and
e. a delivery module operable with the server to deliver the vendor incentive only upon receipt of a unique community identifier corresponding to the at least one target community.

22. The system of claim 21, wherein the vendor management module is configured to retrieve the plurality of communities from the community database and to present the plurality of communities to the at least one vendor.

23. The system of claim 21, wherein the client terminal is selected from the group consisting of computers, portable computers, mobile telephones, personal digital assistants, and kiosks.

24. The system of claim 21, further comprising a vendor incentive database operable with the server, the vendor incentive database having stored therein a plurality of vendor incentives, each of the plurality of vendor incentives being associated with the at least one target community.

25. The system of claim 21, further comprising a member referral module operable with the server and configured to facilitate a referral of the vendor incentive from a first community of the plurality of communities to a second community of the plurality of communities.

26. The system of claim 21, further comprising a messaging module operable with the server and configured to facilitate transmission of a vendor incentive notification from a first member of a community of the plurality of communities to a second member of the community of the plurality of communities.

27. The system of claim 21, wherein the vendor incentive is expiratory.

28. The system of claim 27, wherein the vendor incentive comprises a coupon.

29. The system of claim 21, wherein the browser readable content comprises a member interface, accessible by a member of the at least one target community upon entry of the unique community identifier.

30. The system of claim 29, wherein the browser readable content further comprises a categorical view of a plurality of vendor incentives, each of the plurality of vendor incentives being grouped by a vendor business type.

31. The system of claim 29, wherein the browser readable content further comprises a chronological view of a plurality of vendor incentives, each of the plurality of vendor incentives being grouped temporally.

32. The system of claim 31, wherein the chronological view comprises a calendar.

33. The system of claim 29, wherein the browser readable content comprises a geographical view of vendors.

34. The system of claim 33, wherein the geographical view comprises a map having vendors presented spatially with respect to a community.

35. The system of claim 29, wherein the browser readable content comprises a tabular list of the plurality of approved vendors, wherein each of the plurality of approved vendors is displayed with at least one vendor characteristic.

36. The system of claim 35, wherein the at least one vendor characteristic comprises one of a vendor type or a vendor distance from a querying community.

37. The system of claim 29, further comprising an event management module operable with the server to receive an event notice from an event hosting member of a community selected from the plurality of communities, wherein the event management module is configured to deliver the event notice to the plurality of approved vendors.

38. The system of claim 29, further comprising a vendor request module operable with the server to receive a vendor request from a requesting member of a community selected from the plurality of communities.

39. The system of claim 29, wherein the browser readable content comprises a vendor interface, accessible by a vendor selected from the plurality of vendors upon entry of a vendor identifier.

40. The system of claim 39, further comprising an incentive creation module, the incentive creation module comprising at least an incentive title portal, an incentive description portal, a community selection portal, and an incentive duration portal.

41. The system of claim 39, wherein the browser readable content comprises a geographic view of at least a subset of the plurality of communities.

42. The system of claim 21, further comprising a vendor incentive management module operable with the server and configured to present the web browser readable content in a chronological view comprising a calendar of active vendor incentives sponsored by the at least one vendor.
